(19) United States
(12) Patent Application Publication
(10) Pub. No.: US 2022/0398557 A1
(43) Pub. Date: Dec. 15, 2022

(54) Kiosk Vending Machine

(71) Applicant: Jimmy James Richards, Houston, TX (US)

(72) Inventor: Jimmy James Richards, Houston, TX (US)

(21) Appl. No.: 17/347,341

(22) Filed: Jun. 14, 2021

(51) Int. Cl. G06Q 20/20; G06T 19/00; G06K 7/14

(52) U.S. Cl. CPC G06Q 20/208; G06T 19/006; G06K 7/1413; G06K 7/1417; G06T 2200/24

(57) ABSTRACT

A system for purchasing items, such as hair products is described. The system includes an electronic device and a kiosk. A user can take a selfie from the electronic device. A software converts the picture to an emoji and provide user with different products available. The user can choose a product of interest and collect it from a kiosk vending machine (KVM) located at a place of interest or any nearby location.

### FIELD OF INVENTION

The present invention relates to a kiosk for purchasing items. More specifically, the invention relates to systems and methods for choosing the items from an electronic device and correspondingly collecting the items from a nearby kiosk vending machine (KVMs).

### Background of the Invention

A conventional kiosk vending machine (KVM) includes items in the storage shelves within the KVMs. A user can purchase the items by selecting from menu present on the KVM display and use credit card information to purchase the item of interest from same place locally.

Sometimes, if the item is not present in the storage shelves, the user is not able to access the item from the same place. Moreover, the user is not aware of any other KVM nearby that might provide the item. A US Patent application 20130117137 assigned to Coinstar LLC discloses an interactive kiosk vending machine (KVM). The KVM allows user to voice-over interact with the KVM and purchase the item locally. However, the patent application does not provide a provision to purchase an item remotely.

Another U.S. Pat. No. 7,634,103 assigned to LOreal SA discloses a program to analyze facial image of a user purchasing the item from a website. The program generates an emoji of the user and integrates with the products available on the website. A user can then purchase a product of interest available. However, the patent doesn't provide a suitable way by which a user can dynamically select an item from any location of its choice and collect the item from a kiosk located at another location of choice.

Though former prior art(s) are better and more developed than the previous cited art but they still lack features of purchasing the item online or from a portable electronic device (Eg: Smartphone) and collecting it from nearest kiosk. This saves the risk of carrying money and searching for the item over various stores located at different locations. Hence, there is a need of such systems that provide flexibility and easiness of purchasing items from kiosks placed at different locations and user's choice to collect the items from a KVM at specific location.

It is apparent now that numerous methods and systems are developed in the prior art that are adequate for various purposes. Furthermore, even though these inventions may be suitable for the specific purposes to which they address, accordingly, they would not be suitable for the purposes of the present invention as heretofore described. Thus there is a need for an improved way of shopping from an electronic device and collecting the purchased items from a location nearby.

### Summary of the Invention

An objective of the present invention is to provide a system including an electronic device and a kiosk for choosing an item for purchase. The electronic device includes a program to generate an emoji from an image of a user captured with a camera or else uploaded through the electronic device. The electronic device further includes a database containing images of multiple items to select the item for purchasing. A processor generates a processed image by integrating the emoji with the image. The program further generates a code based on the processed image.

The user generates a request &rom the electronic device to purchase the item. The user can both purchase the item online and collect it from the nearest kiosk. Else, the user can look up for the availability of the item online and can purchase it directly from the kiosk nearby as suggested by the software.

A reader is configured in the kiosk to read the code from the electronic device. The kiosk includes a processor to compare the code with another code stored in the memory. When the code matches another code the item in the processed image is dispensed. As the item is dispensed a counter embedded in the kiosk updates the count in the database which is further shared with the server to maintain the updated information about all the kiosks.

Other objectives and aspects of the invention will become apparent from the following detailed description, taken in conjunction with the accompanying drawings, which illustrate, by way of example, the features in accordance with embodiments of the invention.

Embodiments of the present invention may employ any or all of the exemplary aspects above. Those skilled in the art will further appreciate the above-noted features and advantages of the invention together with other important aspects thereof upon reading the detailed description that follows in conjunction with the drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

Embodiments of the invention are described with reference to the following drawings, wherein:

FIG. 1 illustrates a system for purchasing an item;

FIG. 2a illustrates a smart phone embedded with a software application to purchase an item;

FIG. 2b illustrates a computer with a web interface to purchase an item;

FIG. 3 illustrates a server of a system to purchase an item;

FIG. 4 illustrates a kiosk vending machine of a system to purchase an item; and

FIG. 5 illustrates a method for dispensing an item from a kiosk.

### DETAILED DESCRIPTION OF THE DRAWINGS

The present invention is to provide a system including an electronic device and a kiosk for choosing an item for purchase. The electronic device includes a program to generate an emoji from an image of a user captured with a camera or else uploaded through the electronic device. The electronic device further includes a database containing images of multiple items to select the item for purchasing. A processor generates a processed image by integrating the emoji with the image. The program further generates a code based on the processed image. A reader is configured in the kiosk to read the code from the electronic device. The kiosk includes a processor to compare the code with another code stored in the memory. When the code matches another code the item in the processed image is dispensed.

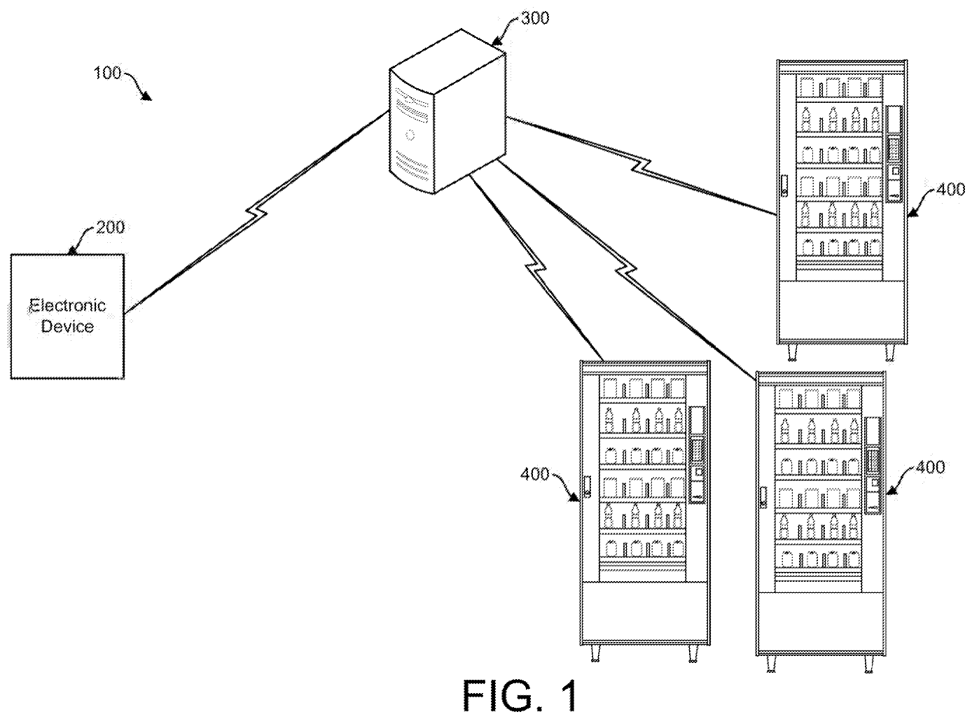

FIG. 1 illustrates a system 100 for purchasing an item such as women's hair bundles and beauty supplies and men's barbering supplies. The system includes an electronic device 200, a server 300 and a kiosk 400 containing the items. In a preferred embodiment, the electronic device is a smart phone. In the other embodiment the electronic device can be a phone, tab, I-Pad, desktop or laptop.

The electronic device 200 includes a software program or a web interface installed and running on the electronic device, a camera within the electronic device is integrated with the software program which includes database containing a number of images of the items, a processor and a memory. A user is capable of uploading a facial picture to the software program from the electronic device. Preferably, the user takes a facial picture through the camera integrated with the software program. Else the user can select the facial picture from the pictures stored in the memory of the electronic device. The software program generates an emoji of the facial picture of the user, where the emoji is a three-dimensional emoji. The software program includes a number of images of the items from its database. The system further includes a processor to generate a processed image by integrating the image with the emoji. The user is capable of editing the processed image based on length of the hair bundles. The length of the hair bundles can be adjusted between small, medium and large length.

The user selects the processed image to purchase the item from the software program. The user can purchase the product online or can visit the suggested kiosk by the software application, directly to buy the item. Preferably, the user conducts a purchase online a code is generated by the software program at the electronic device. The code is a numeric code, a password, a pin code, an alpha-numeric code or the like. Based on the item selected, the software sends the information to the server.

The server 300 includes a receiver for receiving the information, a processor for processing the information of the item purchased. The processor then checks the information about the item in the database and transmits the information through a transmitter. The transmitter then sends a location allocated indicating the presence of the item in the kiosk 400 to the electronic device. The server includes a locator to allocate the preferable kiosk from the multiple kiosks 400. The location allocation is based on the location of the user and availability of the kiosk 400 containing the item near the location of the user.

The system includes multiple kiosk 400 at multiple locations. The kiosk includes a reader for reading the code generated at the electronic device. The kiosks 400 further includes a processor coupled to a database. The database stores another code. The processer compares the code with the other code stored in the database. When the code matches the other code the item is fetched from a storage unit and is dispensed by the dispensing unit by the kiosk.

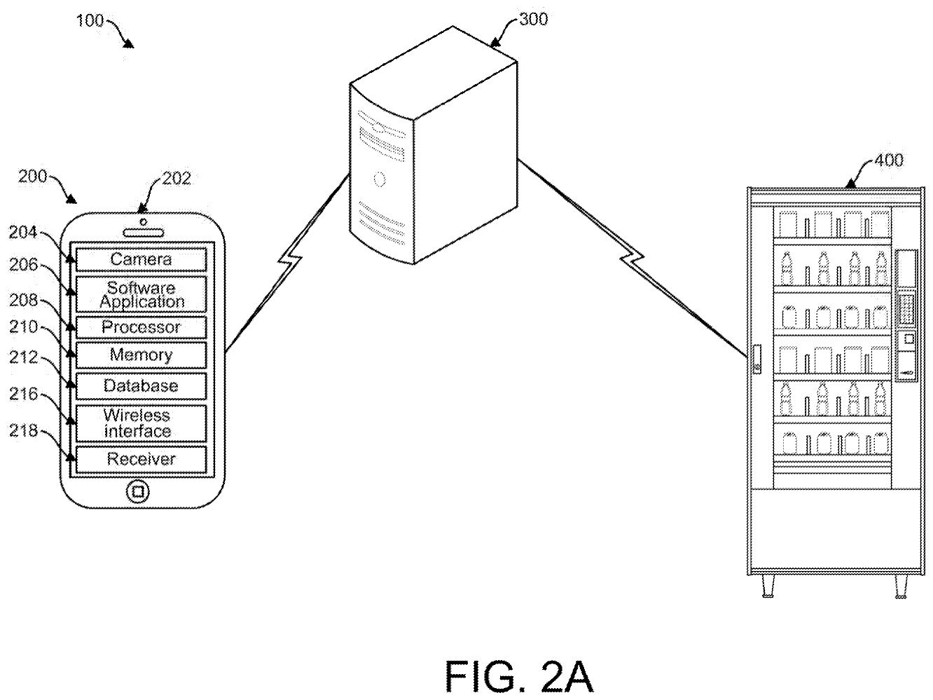

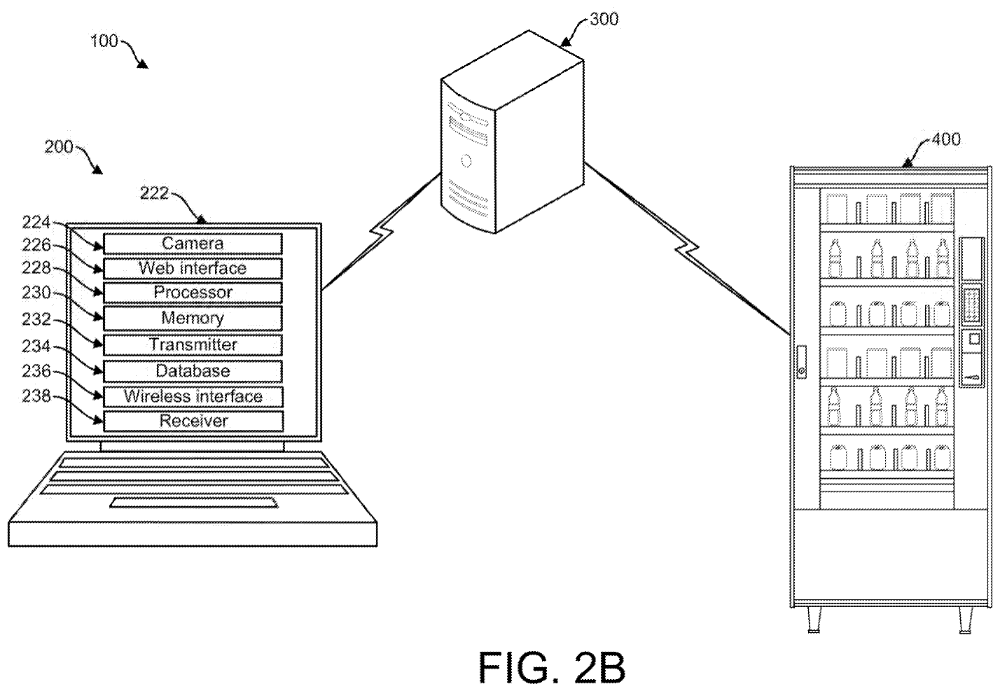

FIG. 2a illustrates a smart phone with a software application to purchase an item. The item is present in a kiosk vending machine 400. The smart phone 202 of the system 100 is used to purchase an item through clicking an image. The user takes a facial picture through the camera 204 integrated with the software application 206. The smart phone 202 includes a software application 206 installed on the smart phone 202, a camera 204 integrated with the software application 206, a processor 208, a memory 210, a transmitter 212, a database 214, a wireless interface 216 to detect the location of the user, and a receiver 218. The software application 206 is preferably an application installed in the smart phone 202. The smart phone 202 retrieves the facial picture stored within its memory 210 clicked by the camera 204. A user is capable of uploading a facial picture on the software application 206 from a memory 210 of the smart phone 202. The processor 208 in the software application 206 generates a three-dimensional emoji of the facial picture.

The user enters an item to conduct a purchase. The search conducted is transmitted to a server 300 by the transmitter 212 through wireless interface 216. The database 214 in the smart phone 202 provides stores searching criteria for the selection of different kinds of products. Further, the software application 206 provides the user with a number of images of the items retrieved from a server 300 received by the receiver 218. The user is capable of modifying the processed image by changing length of the hair bundles. The length of the hair bundle can be either small or medium or large. The user can select item using the processed image.

The purchase of the item in the preferred embodiment is an online purchase where a code is generated and location of a kiosk is allocated at the smart phone. In the other embodiment the user can look the item on the software application and can later buy it directly from the allocated kiosk. The code generated during online purchase is a numeric code, a password, a pin code, an alpha-numeric code or the like. The location is allocated on the basis of present location of the user and availability of the item in the nearby kiosk vending machine.

FIG. 2b illustrates a laptop with a web interface to purchase an item. The item is present in a kiosk 400 vending machine. The laptop 222 in the system is used to purchase an item through clicking an image. The user takes a facial picture through the camera 224 integrated with the web interface 226. The laptop 222 includes a web interface 226 on the laptop 222, a camera 224 to click the facial image integrated with the web interface 226, a processor 228 to form a processes emoji from a facial picture, a memory 230 to store the facial images of user, a transmitter 232 to transmit information from laptop 222 to server 300, a database 234 to provide with the searching criteria, a wireless interface 236 to transmit the information from laptop 222 to the server 300, and a receiver 238.

The laptop 222 retrieves the facial picture stored within its memory 230. A user is capable of uploading a facial picture on the web interface 226 from a memory 230 of the laptop 222. The processor 228 of the web interface 226 generates a three-dimensional emoji of the facial picture. The web interface 226 provides the user with a number of images of the items with the preferences stored in the database 234 retrieved from a server 300. The user can select item using the processed image.

The purchase of the item in the preferred embodiment is an online purchase where a code is generated and location of a kiosk 400 is allocated at the laptop 222. In the other embodiment the user can look the item on the web interface 226 and can later buy it directly from the allocated kiosk 400. The code generated during online purchase is a numeric code, a password, a pin code, an alpha-numeric code or the like. The location is allocated on the basis of present location of the user and availability of the item in the nearby kiosk vending machine 400.

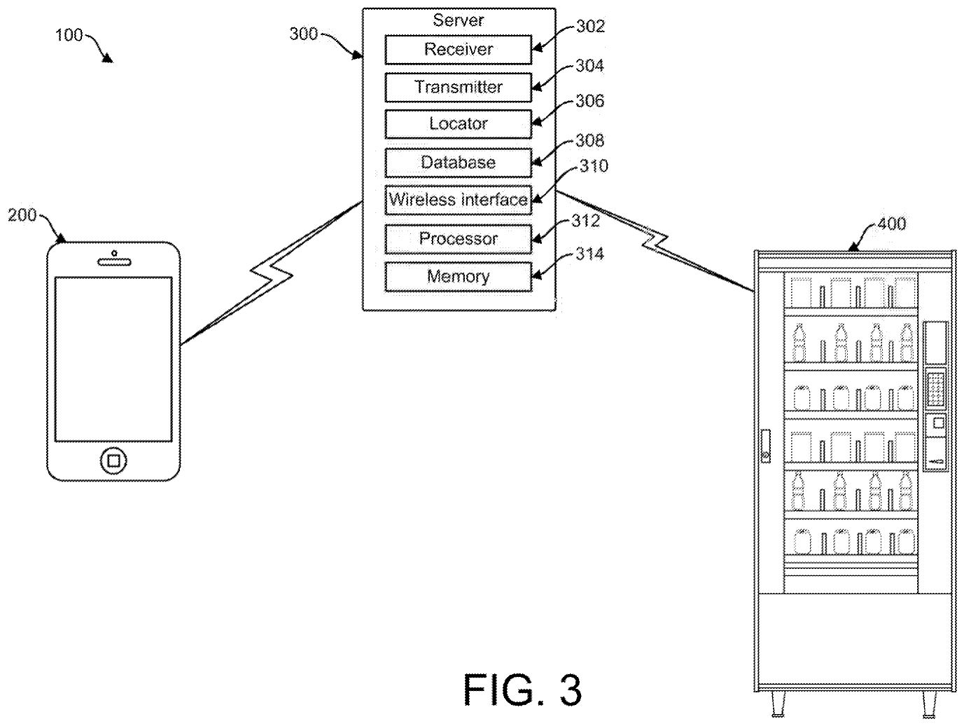

FIG. 3 illustrates a server of a system to purchase an item. The server 300 is integrated with third party website. When a user enters an item the server 300 retrieves the data from the third party website and transfers it to an electronic device 200. The user can further select the item from the provided list of items. The server 300 allocates a location of the electronic device 200 when a code for the item to be purchased is generated through a locator 302. The location is allocated on the basis of present location of a user and availability of the of a kiosk vending machine 400 containing the item. Moreover, the server 300 receives information from the kiosk vending machine 400 and electronic device 200 through a transmitter 304. The transmitter 304 interacts with counter embedded in the kiosk 400 to maintain and let the server 300 know about the count of items left in the kiosk vending machine 400. The server 300 furthermore, serves as a nodal point of communication between the kiosk vending machine 400 and an electronic device 200.

The server 300 can be a cloud based server 300. The server 300 serves as a nodal point for communication between a kiosk vending machine 400 and an electronic device 200 at a remote location. The kiosk vending machine 200 transmits information of an item to the server 300. The kiosk vending machine 200 communicates with the server 300 by using existing wireless communication standards such as 3G, 4G, 5G or the like. The server includes a receiver 302, a transmitter 304, a locator 306, a database 308, a wireless interface 310 and a processor 312 coupled to a memory 314.

The receiver 302 receives information from both the electronic device 200 and kiosk vending machine 400. The information received from the electronic device 200 is the type of requirement from a user and code of a selected item. Also the server 300 receives the availability, number of items left, temperature, shelf life and tampering status of the item from the kiosk 400. The information received is stored in the memory 314.

The memory 314 can be a temporary storage, such as a cache memory in the memory drive such as Hard Disk, USB or the like. The information is further received by a database 308 or a repository in the server 30). The information includes a unique ID of the tag. The tag is associated with the kiosk vending machine 400. The Information of each item is uniquely identified by the unique LD of the tag placed on the item. The server 300 includes firewall to protect the information stored in the memory 314. The received information is processed by the processor 312. The processor 312 can be a Xeon, an Opteron, an Itanium, a SPARC, an Intel core 2 quad or the like. The information processed by the processor 312 is accessible by the electronic device 200 at a remote location. The processed information is transmitted by the transmitter 304 of the server 300 to the electronic device 200 through the wireless interface 310. The server 300 communicates with the electronic device 200 by using existing wireless communication standards such as 3G, 4G, 5G or the like. The servers 300 also include a locator 306 to locate the kiosk 400. The location is allocated on the basis of present location of the user and availability of the item in the nearby kiosk vending machine 400. The electronic device 200 can be a desktop computer, a mobile phone or any other electronic device with a graphical interface (GUI) such as a dashboard.

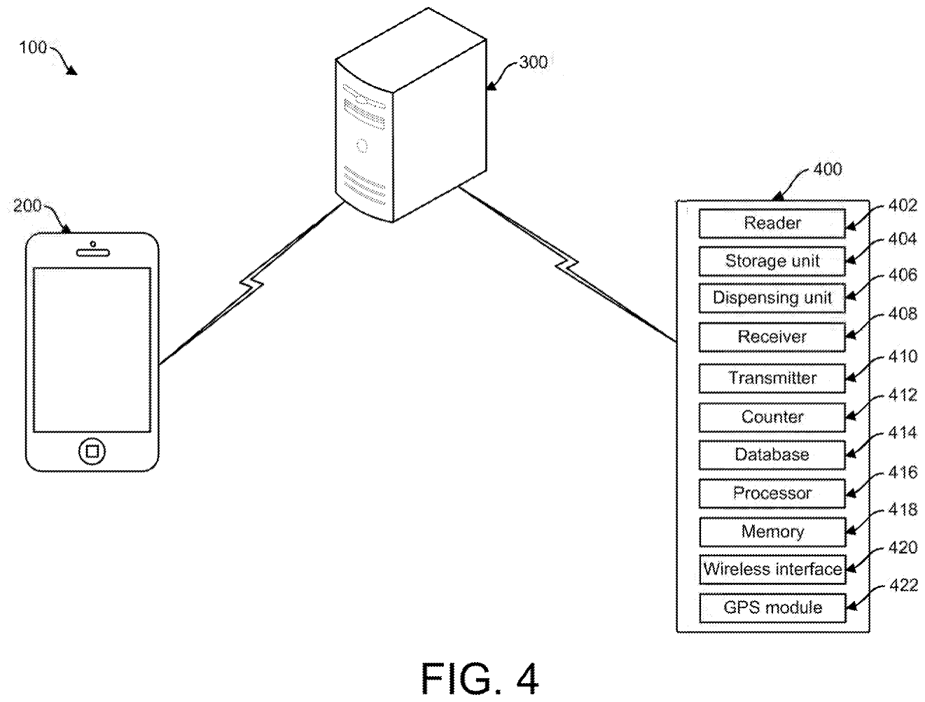

FIG. 4 illustrates a kiosk vending machine of a system to purchase an item. The kiosk 400 communicates with an electronic device 200 to dispense a item selected by the user for purchasing. The kiosk 400 includes a reader 402, a storage unit 404, a dispensing unit 406, a receiver 408, a transmitter 410, a counter 412, a database 414, a processor 416 coupled to a memory 418, a wireless interface 420 and a GPS module 422.

The kiosk vending machine 400 includes a storage unit 404 in which all items are stored. It is also embedded with a counter 412 to maintain the count of all items available after every transition. The count of items is saved in the database 414 which gets updated by the counter 412 after every transition. As soon as a user purchases an item a code is generated. A copy of the code is received by the kiosk 400 receiver 408 through the server 300 and it is temporally saved in the memory 418 of the kiosk vending machine 400. The locator 306 in the server 300 locates the nearest kiosk 400 to the user with the product availability. The GPS module 422 helps the locator 306 to locate the kiosk vending machine 400 and transmit the location to the electronic device 200.

The reader 402 is capable of receiving a code from the electronic device 200. The reader 402 is preferably a scanner, it can also be a wireless input receiving unit or a button based input receiving unit. The reader 402 either scan the code from the electronic device 200 or communicates with the electronic device 200 using existing wireless standards such as 3G, 4G, 5G or the like. The code is a numeric code, a password, a pin code, an alpha-numeric code or the like. The processor 416 compares the code with the coy of the code stored in the memory 418. When the code matches the copy, the item selected by the user for purchasing is fetched from the storage unit 404 and is dispensed by the dispenser unit 406. The counter 412 updates the count in the database 414 and updated information is shared with the server 300 by the transmitter 410 through the wireless interface 420.

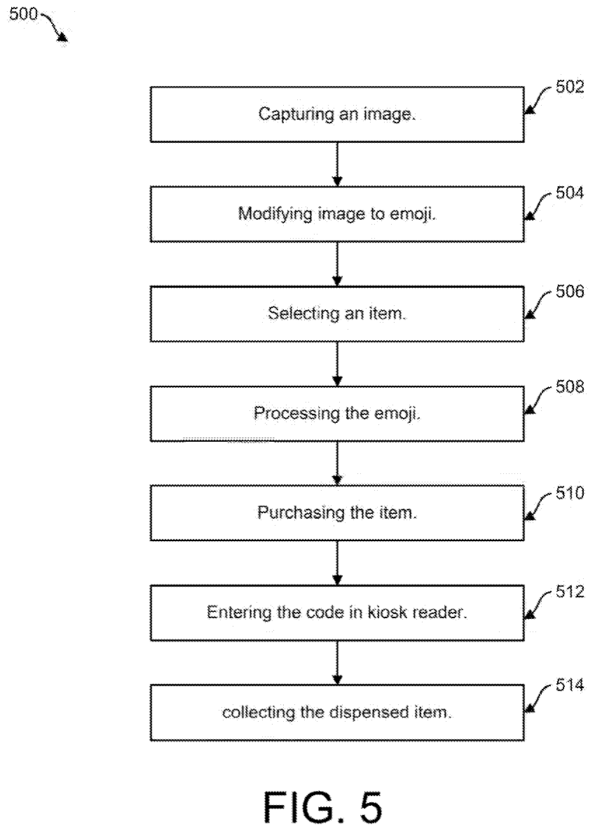

FIG. 5 illustrates a method for dispensing an item from a kiosk. The method 500 comprises, capturing an image 502 of a user from an electronic device integrated with a camera, wherein the image is stored in the memory of the electronic device. Modifying the image to emoji 504, the image clicked is processed through the processor into an emoji. Selecting an item 506, user can select an image of the item from a plurality of images in a database of the electronic device. Processing the emoji 508 where the image which is now the emoji is integrated with the item's image to generate a further processed image through a processor of the electronic device. Purchasing the item 510, user selects an item that he likes and further a code based on the purchase is generated. The information between the electronic device and the kiosk is shared through the server. Entering the code in the kiosk 512, the user can visit the nearby kiosk and enter the code in the reader. Collecting the dispensed item 514, the code is compared with the copy of the code stored in the kiosk. In case the code matches the item is dispensed from kiosk and collected by the user.

While the various embodiments of the present invention have been described above, it should be understood that they have been presented by way of example only, and not of limitation. Likewise, the figure may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

The presence of broadening words and phrases such as “one or more,” “at least,” “but not limited to” or other like phrases in some instances shall not be read to mean that the narrower case is intended or required in instances where such broadening phrases may be absent.

1. A system for choosing an item for purchase, the system comprising:
an electronic device, the electronic device including:
a application integrated with a camera to capture image of a user to generate an emoji;
a database containing images of a plurality of items, wherein the user selects an image of the item in the plurality of items;
a processor for integrating the emoji with the image to generate a processed image;
wherein the application further generates a code based on the processed image;
a kiosk, the kiosk comprising:
a reader for reading the code; and
a processor coupled to a memory, wherein the processor compares the code with another code stored in the memory, further wherein the kiosk dispenses the item when the code matches with the another code.

2. The system according to claim 1, wherein the item is some combination of hair bundles, beauty supplies, or barbering supplies.

3. The system according to claim 2, wherein selection of the image is based on length of the hair bundle.

4. The system according to claim 1, wherein the item is either tobacco leaf wraps, cigarette lighters, playing cards, billiard dominoes, grinders, concentrated oil air fresheners, incense, cbd oil, and cbd products.

5. The system according to claim 1, wherein the emoji is a three dimensional emoji.

6. The system according to claim 1, wherein the code is either of a barcode, a numeric code, a QR code, or a custom software code.

7. The system according to claim 1, wherein the electronic device is either a smart phone, laptop, smart pad, or desktop computer.

8. The system according to claim 5, wherein the user generates a request from the electronic device to purchase the item.

9. The system according to claim 7, wherein the request is submitted on a website or a software application.

10. The system according to claim 8, wherein the request is received by a server, further wherein the server generates the code based on the request and allocates a location to collect the item from the kiosk.

11. The system according to claim 10, where a user can pay for the item on the electronic device or on kiosk.

12. A method for dispensing an item from a kiosk, the method comprising:
capturing an image of a user from an electronic device integrated with a camera, wherein the image is stored as an emoji;
selecting an image of the item from a plurality of images in a database of the electronic device;
integrating the emoji with the image to generate a processed image through a processor of the electronic device; and generating a code based on the processed image;
wherein the code is compared with another code stored in the kiosk for dispensing the item.
